(19) United States
(12) Patent Application Publication
(10) Pub. No.: US 2001/0033905 A1
(43) Pub. Date: Oct. 25, 2001

(54) Absorbers for oils, solvents and coolants

(76) Inventors: Richard G. Middleton, Duluth, GA (US); Marion H. Lesesne III, Isle of Palms, SC (US)

Correspondence Address: MICHAEL A. MANN, NEXSEN PRUET JACOBS & POLLARD LLC, PO DRWR 2426, COLUMBIA, SC, 29202-2426, US

(21) Appl. No.: 09/772,403

(22) Filed: Jan. 29, 2001

Related U.S. Application Data
(60) Provisional application No. 60/178,475, filed on Jan. 27, 2000.

(51) Int. Cl. B32B 1/06

(52) U.S. Cl. 428/35.2; 428/102

(57) ABSTRACT

An oil or solvent absorber in the shape of a sock or pillow made of needle punched polypropylene, melt blown polypropylene, or textiles such as cotton or cotton blends, either by stuffing scraps of material into a cover or rolling sheets and then covering them with a cover or by making a stack of layers of material and then covering the stack of layers with one of these materials.

### FIELD OF THE INVENTION

The present invention relates to articles that absorb oils, solvents and coolants, particularly in an industrial setting. The applicant claims the benefit of the filing date of US provisional patent application Ser. No. 60/178,475, filed Jan. 27, 2000.

### BACKGROUND OF THE INVENTION

In machine shops and other industrial plants, oils, solvents, coolants, and the like, are used extensively. Many of these liquids are harmful to the environment and must be collected and processed prior to disposal, or recycled if possible.

Occasionally, oils and solvents will spill or leak on to the factory floor and need to be contained and cleaned up. There are two particular articles commonly used for these purposes. There are tube-shaped absorbers called “socks”, thin absorbers called “pads”, and thick absorbers called “pillows”. These are often made of polypropylene fibers. Once exposed to oils and solvents, they are usually disposed of. More and more, companies are attempting to recycle these absorbers by having them cleaned. If cleaned, they can be used many times before they begin to lose their physical integrity. Ultimately, they are discarded.

### SUMMARY OF THE INVENTION

According to its major aspects and briefly stated, the present invention is an absorber made by a process and a method for making an absorber. In one embodiment, the absorber is made by stuffing scraps into a tube-shaped or pillow-shaped cover; in another embodiment layers or rolls of material are covered to make a tube or pillow. The covering is either needle punched or melt blown polypropylene. The contents may also be polypropylene or may be a textile such as cotton or a cotton blend.

A feature of the present invention is the use of polypropylene or textile scraps that would otherwise be discarded can continue to be recycled. This lowers the cost of absorbents for oils and solvents.

Another feature of the present invention is the use of sheets of polypropylene or textiles to make both pads and socks. The pads are made of layers of sheets and the socks are made of rolled sheets. Thus, one type of material can be fashioned for use for both containment of spills and clean up of the spills.

Other features and their advantages will be apparent to those skilled in the art of absorbents from a careful reading of the Detailed Description of Preferred Embodiments accompanied by the following drawings.

### BRIEF DESCRIPTION OF THE DRAWINGS

In the drawings,

FIG. 1 is a perspective, partially cut away illustration of an absorbent sock, according to a preferred embodiment of the present invention;

FIG. 2 is a perspective, partially cut away illustration of an absorbent sock, according to an alternative preferred embodiment of the present invention; and

FIG. 3 is a perspective, partially cut away illustration of an absorbent pillow, according to a preferred embodiment of the present invention.

### DETAILED DESCRIPTION OF PREFERRED EMBODIMENTS

The present invention is an oil, solvent or coolant absorber made by a process and a method for making an oil and solvent absorber. There are two shapes of absorbers: tubes or “socks” and pads or “pillows”. The socks are several inches in diameter and may be any convenient length, but preferably a few feet in length. The pads are square or rectangular and may be an inch or more in thickness. If rectangular, they are preferably approximately five inches wide and 16 inches long.

Both types of absorbers are preferably made of either melt-blown or needle-punched polypropylene but may also be made of textiles, such as cotton or cotton blend. Both have a cover made of the same types of material but the cover is preferably thinner than the material inside and may be made of a different type of material than the contents of the sock or pillow. The cover is wrapped about the contents or the contents are forced or stuffed into the cover, and then the cover is sewn with a lock stitch to bind it and to keep the contents within.

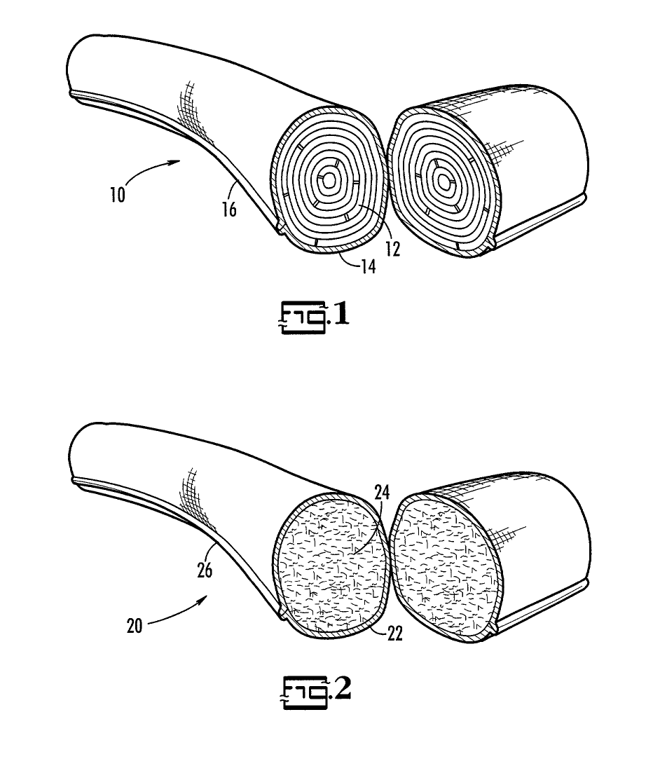

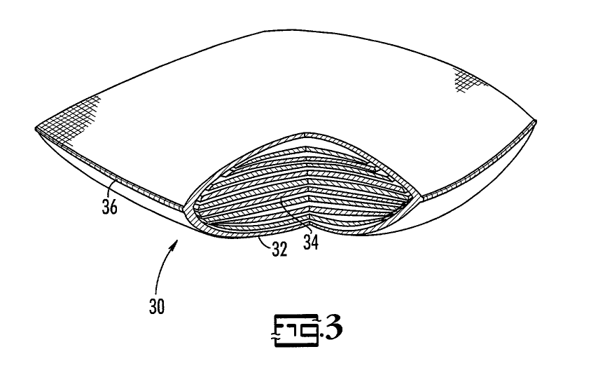

Inside each type of absorber (sock or pillow), the material made by made of layers of sheets either rolled, as shown in FIG. 1, or stacked, as shown in FIG. 3. Alternatively, scraps of material can be stuffed in a sock (FIG. 2) and continue to serve as an oil and solvent absorber through several more cycles of use.

In FIG. 1, there is a sock 10 having a cover 12 with rolled sheets 14 of material inside and a lock stitch seam 16. In FIG. 2, is the alternative sock 20 with a cover 22 but with scraps 24 of material inside and a locks stitch seam 26. Finally, in FIG. 3, there is a pillow or pad 30 with a cover 32 and layers 34 of material inside and also a lock stitch seam 36.

In the present sense, a polypropylene or textile scrap are pieces of material that is either unused but is of a size or dimensions that it has no particular use, or has been used and has started to lose it structural integrity; i.e., it is developing holes or tears, it has gotten thin or less dense, or it has wrinkled or curled

In the form of a pad or pillow, the contents are made of approximately three or more layers of sheeting in a stack. The lock stitch is sewn on three sides with the fourth side resulting from folding a larger piece of material in half. In the case of a tube, the major dimension of a long rectangle of material is sewn with a lock stitch and then the ends are sewn.

It will be apparent to those skilled in the art of making and using absorbent pads and socks, that many modifications and substitutions can be made to the foregoing detailed descriptions without departing from the spirit and scope of the present invention, defined by the appended claims.

What is claimed is:

1. An oil and solvent absorber, comprising:
a cover; and
a stuffing encased within said cover, said stuffing made of melt-blown, needle punched polypropylene,
said cover sealed with a lock stitch.

2. The oil and solvent absorber as recited in claim 1, wherein said cover is made of a material selected from the group consisting of polyproplylene, cotton and cotton blend.

3. The oil and solvent absorber as recited in claim 1, wherein said stuffing is selected from the group consisting of layers of sheets of polypropylene, propylene scraps, of rolls of sheets of polypropylene.

4. An oil and solvent absorber, comprising:
a cover made of polypropylene; and
a stuffing encased within said cover, said stuffing made of polypropylene sheets.

5. The oil and solvent absorber as recited in claim 4, wherein said polypropylene sheets are rolled.

6. The oil and solvent absorber as recited in claim 4 wherein said cover is sealed with a lock stitch.

7. An oil and solvent absorber, comprising:
a polypropylene cover; and
a stuffing encased within said cover, said stuffing made of melt-blown, needle punched polypropylene scraps.

8. The oil and solvent absorber as recited in claim 7, wherein said cover is sealed with a lock stitch.
